(19) United States
(12) Patent Application Publication
(10) Pub. No.: US 2014/0238808 A1
(43) Pub. Date: Aug. 28, 2014

(54) WHEEL HUB FOR A BICYCLE

(71) Applicant: Jui-Ting Lai, Taichung City (TW)

(72) Inventor: Jui-Ting Lai, Taichung City (TW)

(21) Appl. No.: 13/773,636

(22) Filed: Feb. 22, 2013

(51) Int. Cl. F16D 41/12; B60B 27/02

(52) U.S. Cl. CPC F16D 41/12; B60B 27/023
USPC 192/46

(57) ABSTRACT

A wheel hub for a bicycle includes a wheel hub, a ratchet base, a sleeve and a central shaft. The ratchet base has a threaded portion. The sleeve has an outer threaded portion corresponding to the threaded portion. The sleeve has a first abutting end and a second abutting end. The central shaft passes through the wheel hub and inserts into the sleeve. The central shaft has an abutting part defined thereon. A first bearing and a second bearing sleeve onto the central shaft. Under this arrangement, when the sleeve is screwed into the ratchet base, the first abutting end is abutted against the first bearing and the second abutting end is abutted against the second bearing, so that the sleeve is positioned in the ratchet base and the first bearing and the second bearing are positioned precisely.

### BACKGROUND OF THE INVENTION

1. Field of the Invention

The present invention relates to a wheel hub, and more particularly to a wheel hub for a bicycle.

2. Description of Related Art

Bicycle activity is more and more popular in these days because it is eco-friendly, convenient and entertaining. Many people go shopping or go traveling by bicycles during their leisure time. Because a wheel hub for a bicycle is very important for the comfort of riding, the improvement of the wheel hub structure is continuously progressed.

A conventional wheel hub for a bicycle comprises a wheel hub, a central shaft and a ratchet base. The wheel hub has a first receiving hole and a second receiving hole opened at two ends thereof respectively. The first receiving hole and the second receiving hole communicate with each other. The central shaft passes through the first receiving hole and the second receiving hole. The central shaft has a first flange defined at an outer periphery thereof near the first receiving hole. A first bearing sleeves onto the central shaft and abuts against a lateral side of the first flange, and a first cover member is assembled with the first receiving hole, so that two sides of the first bearing is restricted by the first cover member and the first flange. The ratchet base has a third receiving hole and a fourth receiving hole opened at two ends thereof respectively. The third receiving hole and the fourth receiving hole communicate with each other. The central shaft passes through the third receiving hole and the fourth receiving hole. The central shaft has a second flange defined at the outer periphery thereof near the second receiving hole. A second bearing sleeves onto the central shaft and abuts against a lateral side of the second flange. The ratchet base is assembled with the second receiving hole of the wheel hub. A screw member sleeves on the central shaft and corresponds to the third receiving hole. A third bearing sleeves onto the central shaft and abuts against the screw member. An abutting ring sleeves onto the central shaft. The second bearing and the third bearing are abutted against two sides of the abutting ring respectively, so that the second bearing is restricted by the second flange and the abutting ring and the third bearing is restricted by the screw member and the abutting ring. The central shaft has a third flange defined at an outer periphery thereof near the fourth receiving hole. A fourth bearing sleeves onto the central shaft and abuts against the third flange, and a second cover member is assembled with fourth receiving hole, so that the fourth bearing is restricted by the second cover member and the third flange.

However, the conventional wheel hub has two disadvantages as following.

Firstly, the tolerance between the wheel hub and the screw member or the abutting ring is large, so that the screw member and the abutting ring are collided with wheel hub easily. Therefore, the wheel hub will not be rotated smoothly and the inner structure of the wheel hub is damaged easily.

Secondly, the assembling means and the components of the conventional wheel hub are complicated, so that a user detaches or assembles the conventional wheel hub hardly; in addition, the weight of the conventional wheel hub is heavy.

The present invention has arisen to obviate/mitigate the disadvantages of the conventional wheel hub for a bicycle.

### SUMMARY OF THE INVENTION

The main objective of the present invention is to provide an improved wheel hub.

To achieve the objective; a wheel hub for a bicycle comprises a wheel hub, a ratchet base, a sleeve and a central shaft, the wheel hub having a receiving groove defined at one end thereof, one end of the ratchet base inserted into the receiving groove of the wheel hub, the ratchet base having a threaded portion defined at an inner periphery thereof, the sleeve having an outer threaded portion defined at an outer periphery thereof, the outer threaded portion corresponding to the threaded portion and screwed into the threaded portion, the sleeve having a first abutting end defined at one end thereof and a second abutting end defined at another end thereof, the central shaft passing through the receiving groove from one end of the wheel hub and inserts into the sleeve, the central shaft having a first part defined at one end thereof, the first part of the central shaft located in the sleeve, the central shaft having an abutting part defined thereon, a first bearing sleeving onto the central shaft, one end of the first bearing abutted against the abutting part of the central shaft, another end of the first bearing abutted against the first abutting end of the sleeve, a second bearing sleeving onto the central shaft, one end of the second bearing abutted against the second abutting end of the sleeve, a first cover member assembled to the central shaft, one end of the first cover member inserted into the sleeve and abutted against another end of the second bearing. Wherein the central shaft has a first abutting surface defined at the first part thereof; one end of the second bearing is abutted against the first abutting surface; another end of the second bearing is abutted against the first cover member; a distance is defined between the first abutting surface and a center axis of the central shaft; another distance is defined between the abutting part and the center axis of the central shaft; the distance is less than another distance; the abutting part is formed on the central shaft integrally; the abutting part is protruded from an outer periphery of the central shaft; the abutting part is ring-shaped and sleeves onto the central shaft; the first cover member inserts into the ratchet base and screws onto a terminal end of the central shaft, so that the first cover member is abutted against the second bearing; the central shaft has a second part defined at another end thereof; the second part is opposite to the first part of the central shaft; the abutting part is located between the first part and the second part; the abutting part has a first protrusion and a second protrusion; the first protrusion is adjacent to the first part; the second protrusion is adjacent to the second part; one end of the first bearing is abutted against the first protrusion; the wheel hub has a first abutting portion defined in an inner periphery thereof; a third bearing sleeves onto the central shaft; one end of the third bearing is abutted against the second protrusion of the abutting part; another end of the third bearing is abutted against the first abutting portion; wherein a second cover member is screwed into a terminal end of the second part; the second cover member has a second abutting surface defined thereon; the wheel hub has a second abutting portion defined in the inner periphery thereof; a fourth bearing sleeves onto the central shaft; one end of the fourth bearing is abutted against the second abutting portion and the terminal end of the second part; another end of the fourth bearing is abutted against the second abutting surface of the second cover member; an inner diameter of the first bearing is greater than or equal to another inner diameter of the second bearing; an outer diameter of the first bearing is greater than or equal to another outer diameter of the second bearing; an outer periphery of the second bearing is abutted against the inner periphery of the ratchet base.

Under this arrangement, when the sleeve is screwed into the ratchet base, the first abutting end is abutted against the first bearing and the second abutting end is abutted against the second bearing, so that the sleeve is positioned in the ratchet base and the first bearing and the second bearing are positioned precisely.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of a first embodiment of a wheel hub for a bicycle of the present invention;

FIG. 2 is a perspective view of the first embodiment of the wheel hub for a bicycle of the present invention;

FIG. 3 is a cross-sectional view alone line 3-3 of FIG. 2;

FIG. 4 is an exploded view of a second embodiment of a wheel hub for a bicycle of the present invention;

FIG. 5 is a perspective view of the second embodiment of the wheel hub for a bicycle of the present invention; and

FIG. 6 is a cross-sectional view alone line 6-6 of FIG. 5.

### DETAILED DESCRIPTION OF THE INVENTION

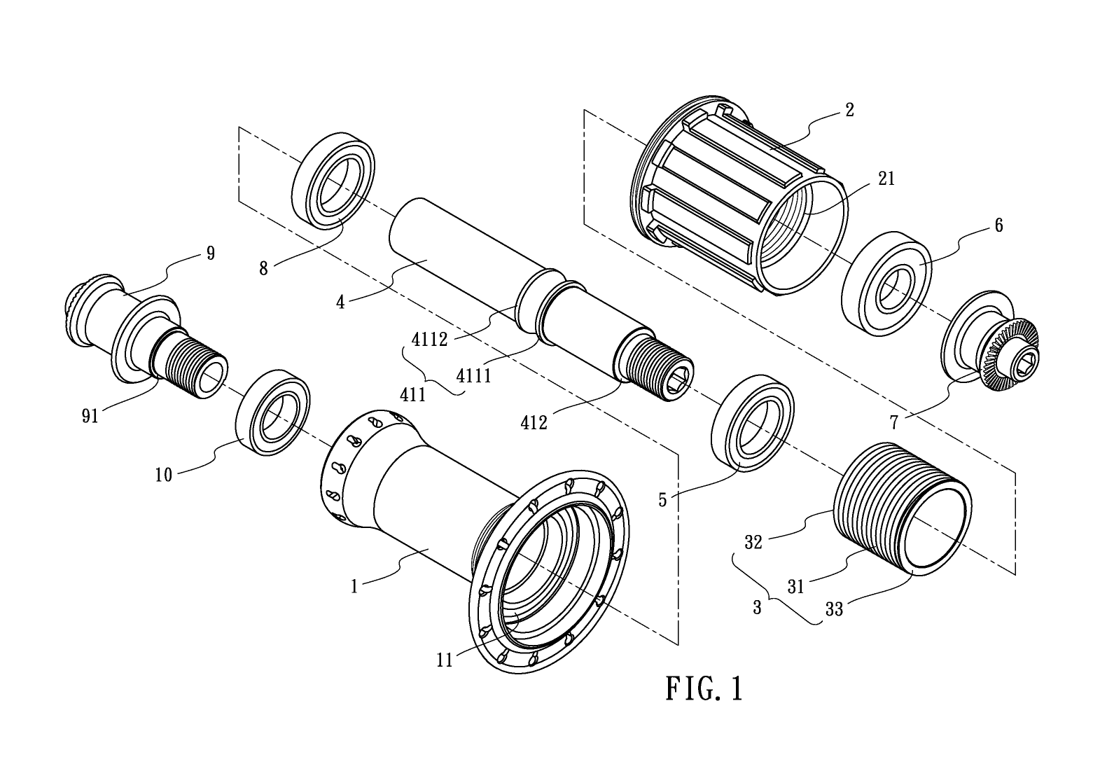

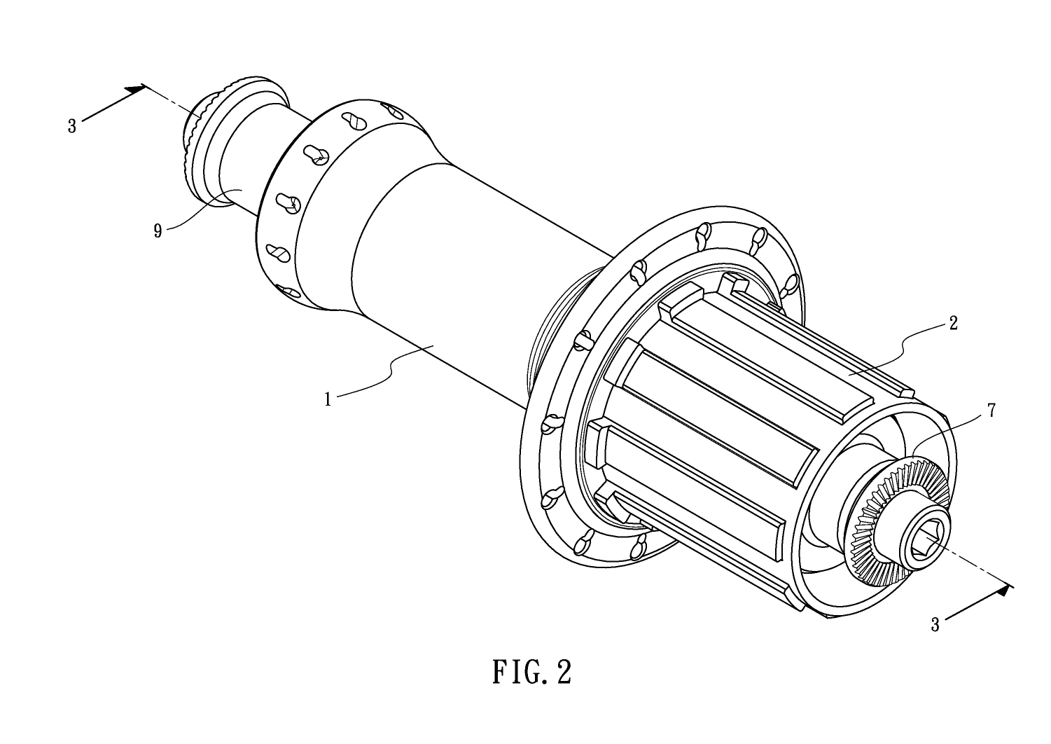

FIGS. 1-3 show a first embodiment of a wheel hub for a bicycle in accordance with the present invention. The wheel hub for a bicycle comprises a wheel hub 1, a ratchet base 2, a sleeve 3 and a central shaft 4.

The wheel hub 1 has a receiving groove 11 defined at one end thereof. One end of the ratchet base 2 is inserted into the receiving groove 11 of the wheel hub 1. The ratchet base 2 has a threaded portion 21 defined at an inner periphery thereof. The sleeve 3 has an outer threaded portion 31 defined at an outer periphery thereof. The outer threaded portion 31 corresponds to the threaded portion 21 and is screwed into the threaded portion 21. The sleeve 3 has a first abutting end 32 defined at one end thereof and a second abutting end 33 defined at another end thereof. The central shaft 4 passes through the receiving groove 11 from one end of the wheel hub 1 and inserts into the sleeve 3. The central shaft 4 has a first part 41 defined at one end thereof. The first part 41 of the central shaft 4 is located in the sleeve 3. The central shaft 4 has an abutting part 411 defined thereon. A first bearing 5 sleeves onto the central shaft 4. One end of the first bearing 5 is abutted against the abutting part 411 of the central shaft 4. Another end of the first bearing 5 is abutted against the first abutting end 32 of the sleeve 3. A second bearing 6 sleeves onto the central shaft 4. One end of the second bearing 6 is abutted against the second abutting end 33 of the sleeve 3. A first cover member 7 is assembled to the central shaft 4. One end of the first cover member 7 is inserted into the sleeve 3 and is abutted against another end of the second bearing 6.

Under this arrangement, when the sleeve 3 is screwed into the ratchet base 2, the first abutting end 32 is abutted against the first bearing 5 and the second abutting end 33 is abutted against the second bearing 6, so that the sleeve 3 is positioned in the ratchet base 2 and the first bearing 5 and the second bearing 6 are positioned precisely.

Furthermore, the assembling steps of the present invention are shown as following:

Firstly, the first bearing 5 sleeves onto the central shaft 4 to the abutting part 411.

Secondly, the sleeve 3 is screwed into the ratchet base 2, and then the second bearing 6 is assembled into the ratchet base 2 with one end of the second bearing 6 being abutted against the second abutting end 33.

Thirdly, two sides of the first bearing 5 are abutted against the abutting part 411 and the abutting end 32 of the sleeve 3 respectively. One end of the second bearing 6 is abutted against the second abutting end 33 of the sleeve 3 and another end of the second bearing 6 is abutted against one end of the first cover member 7.

The first bearing 5 and the second bearing 6 are restricted by the sleeve 3 and the central shaft 4, so that the tolerance of the present invention is minimized. In addition, the gaps between the central shaft 4 and the first bearing 5 or the second bearing 6 are also minimized. Therefore, the friction and the collision between the sleeve 3 and the first bearing 5 or the second bearing 6 are reduced; and the friction and the collision between the central shaft 4 and the first bearing 5 or the second bearing 6 are reduced so as to reduce the generation of noise and the mechanical attrition of the sleeve 3 and the central shaft 4.

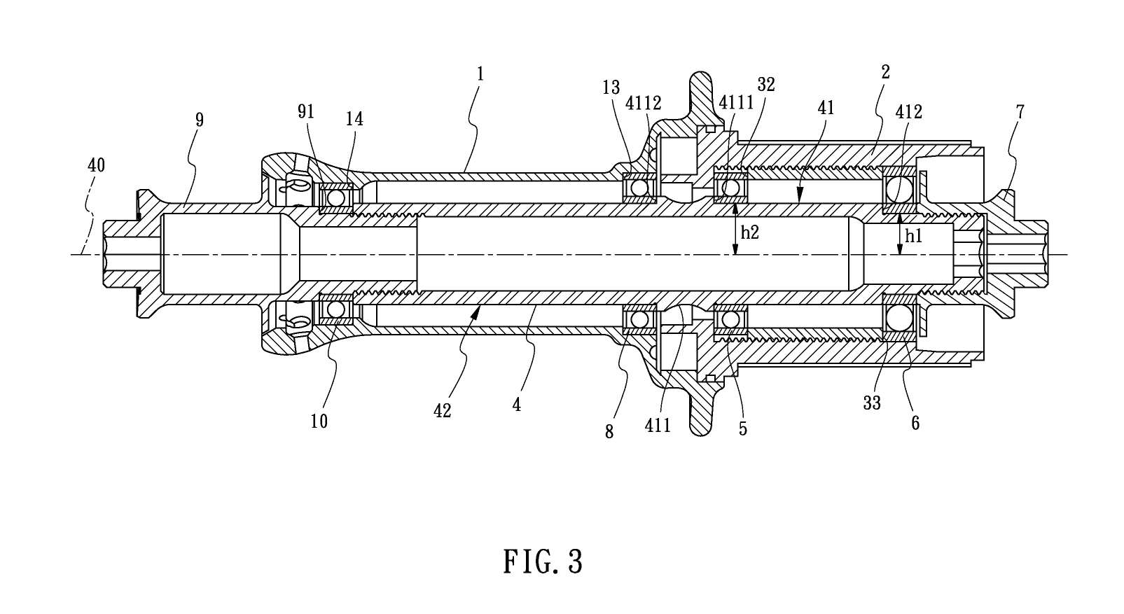

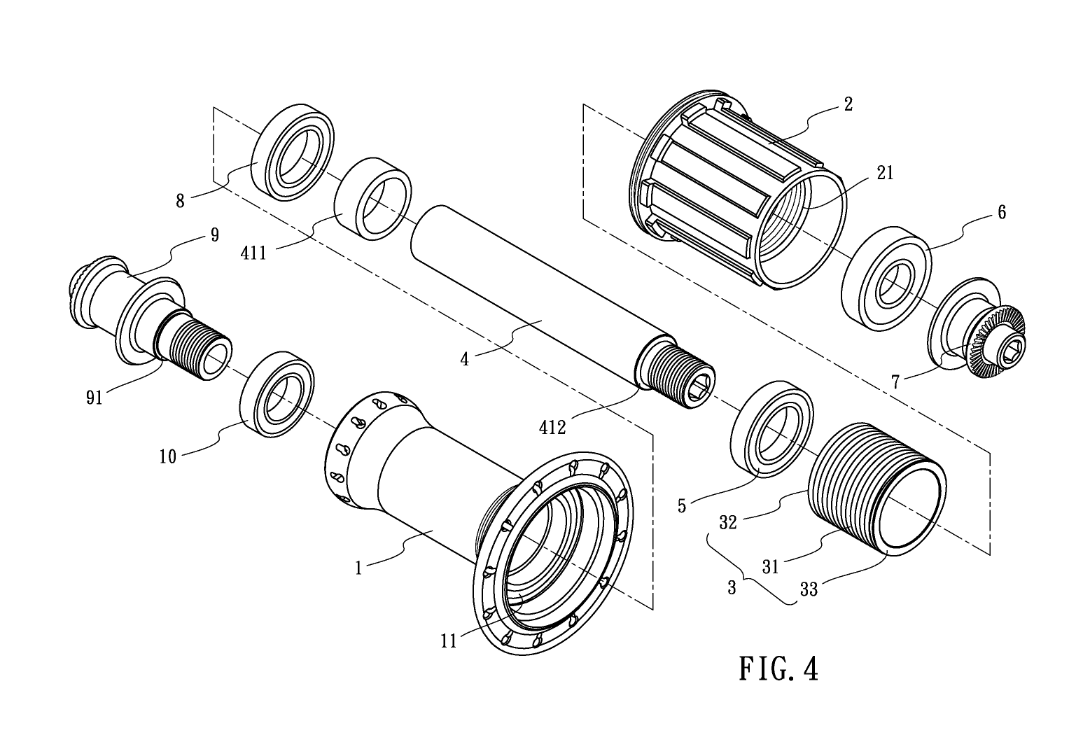

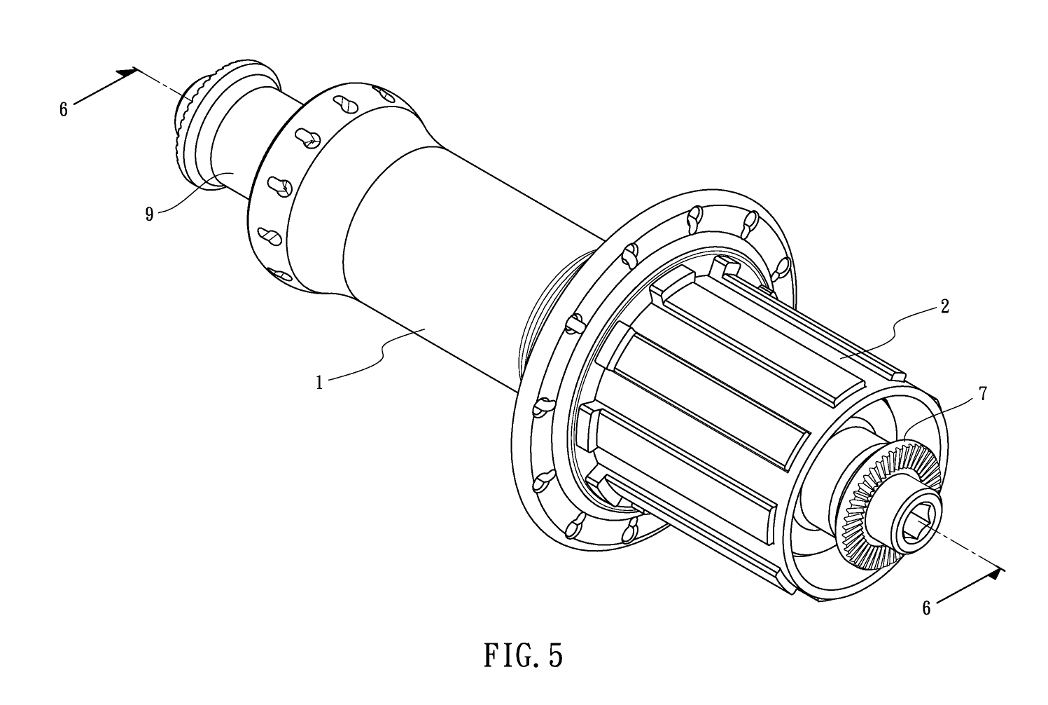

FIG. 3 shows a preferred embodiment of the abutting part 411. The abutting part 411 is formed on the central shaft 4 integrally. The abutting part 411 is protruded from an outer periphery of the central shaft 4. Furthermore, FIGS. 4-6 show another embodiment of an abutting part 411. The abutting part 411 is ring-shaped and sleeves onto the central shaft 4. The above two embodiments of the abutting part 411 are abutted against the bearing steadily.

Referring to FIGS. 1-6, further details are described as following.

The central shaft 4 has a first abutting surface 412 defined at the first part 41 thereof. One end of the second bearing 6 is abutted against the first abutting surface 412. Another end of the second bearing 6 is abutted against the first cover member 7. A distance h1 is defined between the first abutting surface 412 and a center axis 40 of the central shaft 4. Another distance h2 is defined between the abutting part 411 and the center axis 40 of the central shaft 4. The distance h1 is less than another distance h2. Therefore, the disposition of the first abutting surface 412 promotes the positioning effect of the second bearing 6. In addition, the first bearing 5 sleeves onto the central shaft 4 to the abutting part 411 smoothly; in contrast, the first bearing 5 and the second bearing 6 are detached from the central shaft 4 by sliding the first bearing 5 to the first abutting surface 412 along the central shaft 4, so that the first bearing 5 and the second bearing 6 are assembled or disassembled smoothly and quickly.

The first cover member 7 inserts into the ratchet base 2 and screws onto a terminal end of the central shaft 4, so that the first cover member 7 is abutted against the second bearing 6. Therefore, the first cover member 7 is mounted on the central shaft 4 tightly and all components could be positioned securely, so that the wheel hub 1 is operated smoothly.

The central shaft 4 has a second part 42 defined at another end thereof. The second part 42 is opposite to the first part 41 of the central shaft 4. The abutting part 411 is located between the first part 41 and the second part 42. The abutting part 411 has a first protrusion 4111 and a second protrusion 4112. The first protrusion 4111 is adjacent to the first part 41. The second protrusion 4112 is adjacent to the second part 42. One end of the first bearing 5 is abutted against the first protrusion 4111. The wheel hub 1 has a first abutting portion 13 defined in an inner periphery thereof. A third bearing 8 sleeves onto the central shaft 4. One end of the third bearing 8 is abutted against the second protrusion 4111 of the abutting part 411. Another end of the third bearing 8 is abutted against the first abutting portion 13. A second cover member 9 is screwed into a terminal end of the second part 42. The second cover member 9 has a second abutting surface 91 defined thereon. The wheel hub 1 has a second abutting portion 14 defined in the inner periphery thereof. A fourth bearing 10 sleeves onto the central shaft 4. One end of the fourth bearing 10 is abutted against the second abutting portion 14 and the terminal end of the second part 42. Another end of the fourth bearing 10 is abutted against the second abutting surface 91 of the second cover member 9. Therefore, the third bearing 8 and the fourth bearing 10 are positioned in the wheel hub securely. In addition, the second cover member 9 is assembled with the central shaft 4 by means of screw so as to be assembled or disassembled the fourth bearing 10 conveniently.

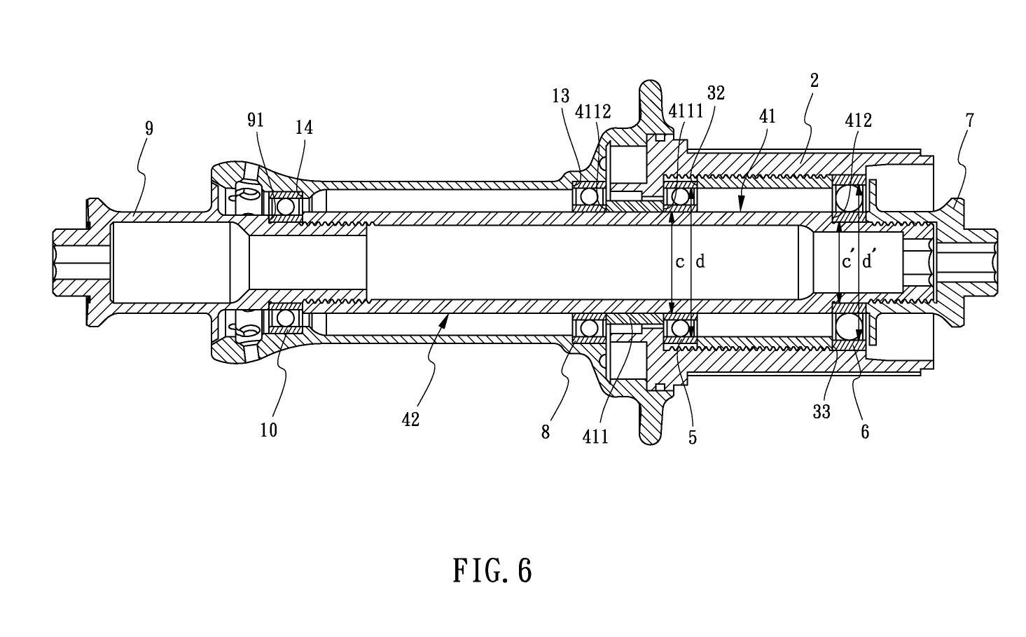

Referring to FIG. 6, an inner diameter c of the first bearing 5 is greater than or equal to another inner diameter c′ of the second bearing 6. An outer diameter d of the first bearing 5 is greater than or equal to another outer diameter d′ of the second bearing 6. An outer periphery of the second bearing 6 is abutted against the inner periphery of the ratchet base 2, so that the ratchet base 2 is rotated relative to the wheel hub 1 smoothly.

The advantages of the present invention are described as following:

1. The sleeve 3 is positioned in the ratchet base 2 by means of screw, so that the sleeve 3 is positioned in the ratchet base 2 securely. Therefore, the sleeve 3 does not slide optionally as the wheel hub 1 is operated, so that the wheel hub 1 is operated smoothly.

2. The first bearing 5 and the second bearing 6 are positioned on the central shaft 4 steadily by few components, so that the wheel hub is operated smoothly.

3. The weight of the wheel hub of the present invention is less than the weight of the conventional wheel hub.

4. When the sleeve 3 is damaged so as to interfere with the operations of the first bearing 5 and the second bearing 6, the sleeve 3 could be substituted by another sleeve 3, so that the user does not need to replace the whole wheel hub and the repairing cost is reduced.

Although the invention has been explained in relations to its preferred embodiment, it is to be understood that many other possible modifications and variations can be made without departing from the spirit and scope of the invention as hereinafter claimed.

What is claimed is:

1. A wheel hub for a bicycle comprising:
a wheel hub, a ratchet base, a sleeve and a central shaft;
the wheel hub having a receiving groove defined at one end thereof;
one end of the ratchet base inserted into the receiving groove of the wheel hub, the ratchet base having a threaded portion defined at an inner periphery thereof;
the sleeve having an outer threaded portion defined at an outer periphery thereof, the outer threaded portion corresponding to the threaded portion and screwed into the threaded portion, the sleeve having a first abutting end defined at one end thereof and a second abutting end defined at another end thereof;
the central shaft passing through the receiving groove from one end of the wheel hub and inserts into the sleeve, the central shaft having a first part defined at one end thereof, the first part of the central shaft located in the sleeve, the central shaft having an abutting part defined thereon;
a first bearing sleeving onto the central shaft, one end of the first bearing abutted against the abutting part of the central shaft, another end of the first bearing abutted against the first abutting end of the sleeve; and
a second bearing sleeving onto the central shaft, one end of the second bearing abutted against the second abutting end of the sleeve, a first cover member assembled to the central shaft, one end of the first cover member inserted into the sleeve and abutted against another end of the second bearing;
wherein, when the sleeve is screwed into the ratchet base, the first abutting end is abutted against the first bearing and the second abutting end is abutted against the second bearing, so that the sleeve is positioned in the ratchet base and the first bearing and the second bearing are positioned precisely.

2. The wheel hub for a bicycle as claimed in claim 1, wherein the central shaft has a first abutting surface defined at the first part thereof; one end of the second bearing is abutted against the first abutting surface; another end of the second bearing is abutted against the first cover member; a distance is defined between the first abutting surface and a center axis of the central shaft; another distance is defined between the abutting part and the center axis of the central shaft; the distance is less than another distance.

3. The wheel hub for a bicycle as claimed in claim 1, wherein the abutting part is formed on the central shaft integrally; the abutting part is protruded from an outer periphery of the central shaft.

4. The wheel hub for a bicycle as claimed in claim 1, wherein the abutting part is ring-shaped and sleeves onto the central shaft.

5. The wheel hub for a bicycle as claimed in claim 1, wherein the first cover member inserts into the ratchet base and screws onto a terminal end of the central shaft, so that the first cover member is abutted against the second bearing.

6. The wheel hub for a bicycle as claimed in claim 1, wherein the central shaft has a second part defined at another end thereof; the second part is opposite to the first part of the central shaft; the abutting part is located between the first part and the second part; the abutting part has a first protrusion and a second protrusion; the first protrusion is adjacent to the first part; the second protrusion is adjacent to the second part; one end of the first bearing is abutted against the first protrusion; the wheel hub has a first abutting portion defined in an inner periphery thereof; a third bearing sleeves onto the central shaft; one end of the third bearing is abutted against the second protrusion of the abutting part; another end of the third bearing is abutted against the first abutting portion.

7. The wheel hub for a bicycle as claimed in claim 6, wherein a second cover member is screwed into a terminal end of the second part; the second cover member has a second abutting surface defined thereon; the wheel hub has a second abutting portion defined in the inner periphery thereof; a fourth bearing sleeves onto the central shaft; one end of the fourth bearing is abutted against the second abutting portion and the terminal end of the second part; another end of the fourth bearing is abutted against the second abutting surface of the second cover member.

8. The wheel hub for a bicycle as claimed in claim 1, wherein an inner diameter of the first bearing is greater than or equal to another inner diameter of the second bearing; an outer diameter of the first bearing is greater than or equal to another outer diameter of the second bearing; an outer periphery of the second bearing is abutted against the inner periphery of the ratchet base.
